(19) United States
(12) Patent Application Publication
(10) Pub. No.: US 2015/0120314 A1
(43) Pub. Date: Apr. 30, 2015

(54) METHOD AND APPARATUS FOR REPRESENTING SYMPTOMS GRAPHICALLY

(71) Applicant: Electronics and Telecommunications Research Institute, Daejeon (KR)

(72) Inventors: Hyeon-Sung CHO, Daejeon (KR); Rock-Won KIM, Daejeon (KR)

(21) Appl. No.: 14/458,181

(22) Filed: Aug. 12, 2014

(30) Foreign Application Priority Data
Oct. 31, 2013 (KR) 10-2013-0131709

(51) Int. Cl. G06F 19/00

(52) U.S. Cl. CPC G06F 19/345; G06F 19/3437
USPC 705/2

(57) ABSTRACT

Disclosed herein are a method and an apparatus for representing symptoms graphically. The present invention has been made in an effort to provide a method and an apparatus for representing symptoms graphically which may allow the general public to easily and accurately input and store their own symptoms using a digital apparatus and transfer the stored symptoms to other systems or applications.

### CROSS REFERENCE TO RELATED APPLICATION

This application claims the benefit of Korean Patent Application No. 10-2013-0131709, filed on Oct. 31, 2013, entitled “Method And Apparatus For Representing Symptoms Graphically”, which is hereby incorporated by reference in its entirety into this application.

### BACKGROUND OF THE INVENTION

1. Technical Field

The present invention relates to a method and an apparatus for representing symptoms graphically.

2. Description of the Related Art

At present, medical service institutions, such as a hospital, a medical clinic, and a medical institution, have increased and patients receiving medical services which are provided by these institutions have increased. The medical service institutions may no longer perform a medical practice just by using a traditional paper document as the number of patients increases.

Recently, a management system using a computer to handle the medical practice has been introduced to solve the above problem, but a doctor still needs to see data in the paper document to refer to considerations which are required to treat or operate a patient. Otherwise, there is a need to search for and refer to data on the Internet. However, since the data are separately present from an electronic chart in which patient information to be continuously managed is stored and managed, the data are difficult to be utilized as information which is fragmentary and is suited for individual conditions of patients.

Meanwhile, health is an eternal problem of human and has been ceaselessly pursued by people. As services, such as u-health and private health care, have been introduced keeping up with the digital era, tries to graft digitalized information on each user onto a solution of medical and health problem have been frequently conducted.

However, it is very difficult for the general public to clearly express medical expertise and reflect the medical expertise to digitalized data and it is practically impossible for the general public to clearly express their own symptoms using a terminology.

The technical problem occurring in this situation is that the general public may not accurately express their own conditions and thus an expert or a computer may not accurately recognize the expression of the general public. That is, a communication problem on digitalization of symptom expression of the general public is at the base. Therefore, a method and an apparatus to efficiently solve the above problem are urgently required.

### SUMMARY OF THE INVENTION

The present invention has been made in an effort to provide a method and an apparatus for representing symptoms graphically which may allow the general public to easily and accurately input and store their own symptoms using a digital apparatus and transfer the stored symptoms to other systems or applications.

Further, the present invention has been made in an effort to provide a method and an apparatus for representing symptoms graphically which may allow a medical expert or a computer to accurately process symptom information on a user.

According to an exemplary embodiment of the present invention, there is provided a method for representing symptoms graphically, including: displaying a body model on a display; receiving a first touch signal for a location corresponding to a symptomatic site in the body model; enlarging the location corresponding to the symptomatic site at which the first touch signal is received; displaying internal organs corresponding to the enlarged location; receiving a second touch signal at any one of the internal organs; displaying an organization map of the internal organs corresponding to the location at which the second touch signal is received; receiving a general symptom expression which is generated from an organization corresponding to the organization map; acquiring a medical symptom expression by searching for the medical symptom expression corresponding to the general symptom expression from a medical specialty database; and searching for possible disease names based on information on the medical symptom expression and the organization.

The method for representing symptoms graphically may further include: displaying information on any one of an occurrence cause of disease corresponding to the disease name, a treatment method, and a recommendation hospital.

The method for representing symptoms graphically may further include: prior to the receiving of the general symptom expression which is generated from the organization corresponding to the organization map, displaying the general symptom expression or the medical symptom expression which is generated from the organization corresponding to the organization map.

The organization map of the internal organs may include an organization map for any one of the internal organs.

The first touch signal and the second touch signal may be signals which are generated by changing an electrical signal in the display using a capacitive type or a constant pressure type.

The enlarging of the location corresponding to the symptomatic site at which the first touch signal is received may be performed several times.

The method for representing symptoms graphically, further including: displaying the disease name on the display.

The disease name may be ascites.

The method for representing symptoms graphically may further include: displaying essential symptom in the disease name; and displaying only the disease name including the essential symptom when the signal selecting the essential symptoms is received.

The displaying of the only the disease name including the essential symptom may include arranging the disease names having high possibility of occurrence of essential symptoms in an ascending order or a descending order to represent only the disease name.

The medical specialty database may be a database including data obtained by matching the general symptom expression with the medical symptom expression.

According to another exemplary embodiment of the present invention, there is provided an apparatus for representing symptoms graphically, including: a display unit configured to display a body model, internal organs, an organization map of the internal organs; an input unit configured to receive a first touch signal and a second touch signal to display the internal organs and the organization map of the internal organs by enlarging the body model and receive the general symptom expression which is generated from an organization corresponding to the organization map; and a communication unit configured to transmit the general symptom expression to a medical specialty server and receive possible disease names based on a medical symptom expression corresponding to the general symptom expression and information on the medical symptom expression and the organization from the medical specialty server.

The medical specialty server may include: a communication module configured to receive the general symptom expression from the communication unit; a searching unit configured to search for the medical symptom expression corresponding to the general symptom expression; a general symptom expression DB configured to store the general symptom expression; a medical symptom expression DB configured to store the medical symptom expression corresponding to the general symptom expression; and a disease name DB configured to store the disease name corresponding to the medical symptom expression.

### BRIEF DESCRIPTION OF THE DRAWINGS

FIG. 1 is a flow chart of a method for representing symptoms graphically according to an exemplary embodiment of the present invention.

FIG. 2 is a diagram illustrating a body model of the method for representing symptoms graphically according to the exemplary embodiment of the present invention.

FIG. 3 is an enlarged view of the body model of the method for representing symptoms graphically according to the exemplary embodiment of the present invention.

FIG. 4 is an enlarged view of internal organs of a body model of the method for representing symptoms graphically according to the exemplary embodiment of the present invention.

FIG. 5 is a block diagram of an apparatus for representing symptoms graphically according to an exemplary embodiment of the present invention.

FIG. 6 is a diagram schematically illustrating a screen implemented by the apparatus for representing symptoms graphically according to the exemplary embodiment of the present invention.

### DESCRIPTION OF EXEMPLARY EMBODIMENTS

Since the present invention may be variously modified and have several exemplary embodiments, specific exemplary embodiments will be shown in the accompanying drawings and be described in detail in a detailed description. However, it is to be understood that the present invention is not limited to the specific exemplary embodiments, but includes all modifications, equivalents, and substitutions included in the spirit and the scope of the present invention. Further, the terminologies used in the present invention are selected as general terminologies currently widely used in consideration of the configuration and functions of the present invention, but may be different depending on intention of those skilled in the art, a precedent, appearance of new technologies, and the like. Further, in specific cases, terms arbitrarily selected by an applicant are present. In this case, the detailed meaning of the terms will be described in the description of the present invention. Therefore, terms used in the present invention are defined based on a meaning of the terms and contents described in the present invention, not simply based on names of the terms.

Hereinafter, exemplary embodiments of the present invention will be described in detail with reference to the accompanying drawings.

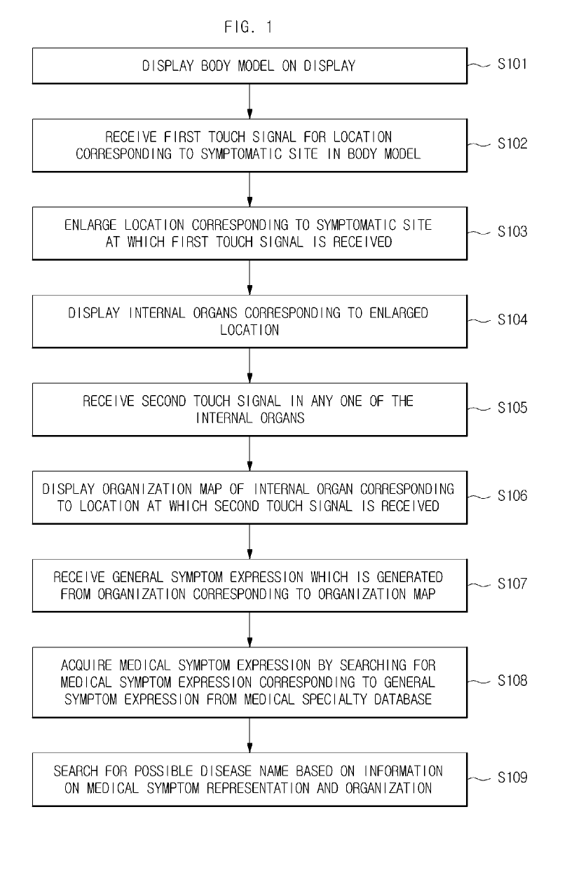

FIG. 1 is a flow chart of a method for representing symptoms graphically according to an exemplary embodiment of the present invention.

Referring to FIG. 1, a method for representing symptoms graphically according to an exemplary embodiment of the present invention may include: displaying a body model on a display; receiving a first touch signal for a location corresponding to a symptomatic site in the body model; enlarging the location which receives the first touch signal and corresponds to the symptomatic site; displaying internal organs corresponding to the enlarged location; receiving a second touch signal from any one of the internal organs; displaying an organization map of the internal organs at a location receiving the second touch signal; receiving a general symptom expression which may be generated from an organization corresponding to the organization map; searching for a medical symptom expression corresponding to the general symptom expression from a medical specialty database to obtain the medical symptom expression, and searching for possible disease names based on the medical symptom expression and information on the organization.

In step S101, the body model may be displayed on the display. The body model may include the whole shape of a person, but any body model to help a user select a symptomatic site, seeing the body model displayed on the display may be used without being particularly limited. For example, the body model may include a skin tissue chart, an anatomical chart, and a blood vessel relationship chart of a person.

The display may include a unit which may display the body model and receive the touch signal from the user. For example, the display may be any one selected from a liquid crystal display (LCD), a single-chip digital light processing (DLP) projector, a three-chip digital light processing (DLP) projector, a cathode ray tube (CRT), a plasma display panel, a liquid crystal on silicon (LCS), a holographic images on transparent screen, and organic light emitting diode (OLED).

In step S102, the first touch signal for the location corresponding to the symptomatic site in the body model may be received. The user may select the symptomatic site, seeing the body model. The symptomatic site may include an aching site. Further, the symptomatic site may include a site at which a lesion occurs physically. Further, the symptomatic site may include a site which may be recognized by a contact from the outside, due to a lump which is present within a user's body.

Meanwhile, the first touch signal may include a signal which is generated by changing an electrical signal in the display using a capacitive type or a constant pressure type. For example, when the display is a touch screen, the user uses a user's hand or a touch tool to be able to touch the symptomatic site in the body model. The method for representing symptoms graphically according to the exemplary embodiment of the present invention may receive the first touch signal through the display.

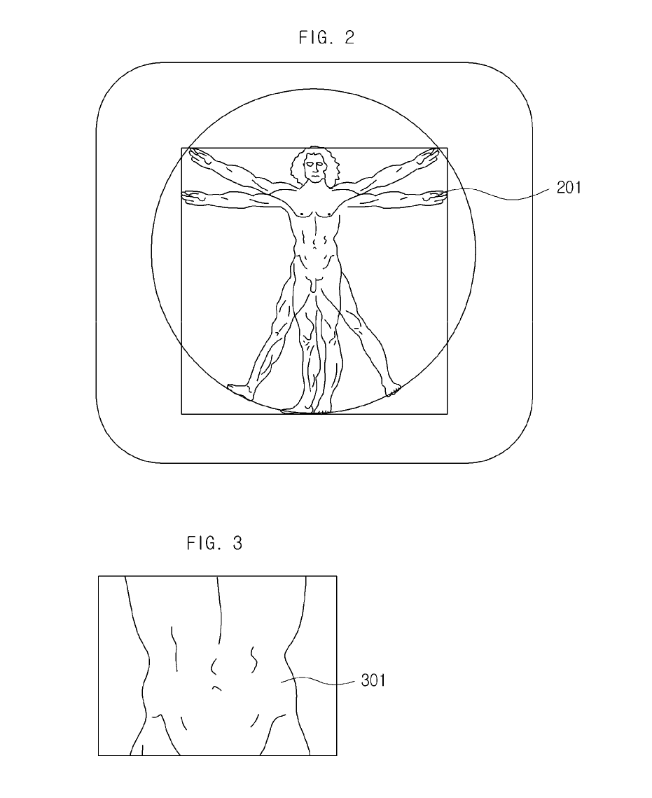

In step S103, the location corresponding to the symptomatic site receiving the first touch signal may be enlarged. In step S101, the body model includes the whole human drawing and therefore a site touched by the first touch signal may be enlarged to allow the user to clearly search for the symptomatic site. The enlarged site may include a body site which is located within a predetermined radius based on the site receiving the touch signal. Here, the enlarged number of times may be several times. When the symptomatic site is touched several times, the symptomatic site may be enlarged in response to the touched number of times. The enlarged site may include a site at which a lesion may occur based on the touched site so as to allow the user to search for the symptomatic site. Referring to FIGS. 2 and 3, as illustrated in reference numeral 201, the user confirms the body model through the display and confirms the symptomatic site to touch the symptomatic site, such that he/she may confirm the enlarged body model based on the symptomatic site as illustrated in FIG. 3. According to the exemplary embodiment of the present invention, when an abdomen site as illustrated in reference numeral 201 is touched, the abdomen site is enlarged and the enlarged drawing or photograph as illustrated in reference numeral 301 may be confirmed.

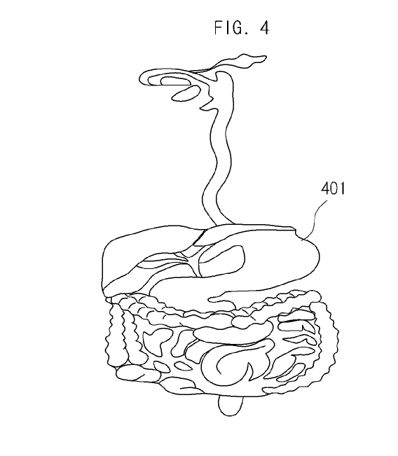

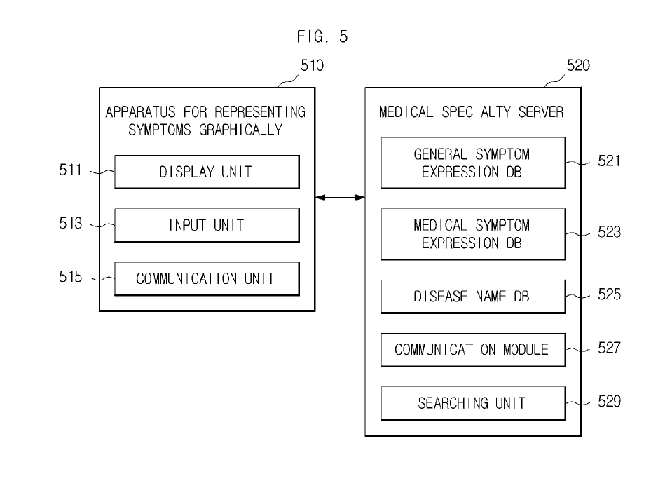

Referring back to FIG. 1, in step S104, the internal organs corresponding to the enlarged location may be displayed. As illustrated in reference numeral 401 of FIG. 4, in step S103, the symptomatic site is enlarged and then, in step S104 the internal organs at the enlarged site may be displayed. In this case, the user selects the symptomatic organ and may thus more enlarge and confirm a specific organ. Further, to clearly confirm the symptomatic organ, the symptomatic organ may be displayed in a rotating form, a top/bottom inverted form, a left/right inverted form by a user operation. Further, an organ touched by the user is more enlarged or is represented by different colors, such that the touched organ may be represented to be differentiated from other organs.

In steps S105 and S106, any one of the internal organs may receive a second touch signal and an organization map of the internal organs at a location at which the second touch signal is received may be displayed. Herein, the organization map may include an organization configuration diagram of the symptomatic organ. Further, the organization map may include an anatomical chart. The anatomical chart may represent a relationship between the symptomatic organ and organs therearound. According to the exemplary embodiment of the present invention, the organization map may be represented by a three-dimensional graphic. In the organization map represented by the three-dimensional graphic, each cell and tissue may be represented by different colors. According to the exemplary embodiment of the present invention, the organization map of the internal organs may include an organization map for any one of the internal organs. When the user selects the specific organ, he/she may represent the organization map for the selected organ. Here, the organization map for the selected organ may be an organization map including a cell phase. For example, the user may select an abdomen site and then a large intestine and when the organization map of the large intestine is represented, the user may select a descending colon site of the large intestine and may select and enlarge a sigmoid colon in the descending colon. Further, the second touch signal may be performed by the same method as the method of inputting the first touch signal.

In step S107, the general symptom expression which may be generated from the organization corresponding to the organization map may be received. The general symptom expression may include a symptom expression which is used by a person other than a medical expert. For example, the general symptom expression that a lump is touched at a right lower abdomen may correspond to the medical symptom expression associated with hepatocirrhosis. To help understanding, for example, a general symptom expression that a lump is touched at a right lower abdomen and a general symptom expression that an abdomen is big or swells up may correspond to a medical symptom expression that ascites collects. The general symptom expression may be different depending on a use of language and may include a regional dialect in consideration of local color. For example, when kidney is symptomatic, the general public without medical expertise may express that kongpat has a problem, in which the kidney may correspond to the medical symptom expression and the kongpat may correspond to the general symptom expression.

According to another exemplary embodiment of the present invention, the method for representing symptoms graphically may further include a step of representing the general symptom expression or the medical symptom expression prior to a step of receiving the general symptom expression which may occur from the organization corresponding to the organization map. By the step of representing of the general symptom expression or the medical symptom expression which may occur from the organization, the user may perform inputting based on a method for selecting a step of directly inputting the general symptom expression from the represented general symptom expression.

According to the related art, it is difficult for the general public to express their own conditions and the accuracy of expression may be reduced. Further, it is impossible for an expert or a computer to accurately recognize their expression and therefore it is difficult to provide a medical service via the Internet. The method for representing symptoms graphically according to the exemplary embodiment of the present invention has an effect of solving a communication problem by digitalizing the symptom expression of the general public and the effect may be achieved by a method for matching the general symptom expression with the medical symptom expression.

In step S108, the medical symptom expression may be obtained by searching for the medical symptom expression corresponding to the general symptom expression from the medical specialty database. According to the exemplary embodiment of the present invention, the general symptom expression received from the user may be transmitted to a medical specialty server. In this case, the medical specialty server may include anatomical division information of a specific human body, specific functional division information of a human body such as endocrine, psychiatric, central nervous system, and circulatory system, characteristic unit functional element information of a human body such as walking, sleeping, and running, factor information by age such as newborn baby, young child, climacterium, and old man, disease information related to a shape of a human body such as spinal deformity and congenital malformation, parasite, virus, bacteria information which is a cause of a specific infectious disease, neoplastic disease information such as malignant tumor and benign tumor, characteristic histopathological opinion information, specific material information which affects a human body due to toxicity and pollution, environmental element information such as air, water, temperature, humidity, distribution of animals and plants, and geographical characteristics, specific disaster element information such as traffic accident, fire, war, earthquake, and volcano, and information on emergency or chronic disease. Further, the medical specialty server may include the medical symptom expression corresponding to the general symptom expression and may further include information on a key which may match the general symptom expression with the medical symptom expression. Herein, the information on the matching key may include a matching key which may be deformed or changed depending on the development stage of language.

In step S109, the disease name may possibly be searched based on the medical symptom expression and the information on the organization. The medical symptom expression corresponding to the general symptom expression may be searched based on the matching key. According to the exemplary embodiment of the present invention, the general symptom expression “vomit blood” is divided into a noun and a verb of “blood” and “vomit” and the medical expressions corresponding to “blood”, that is, “hyeol aek”, “hyeol”, “bleod” “hemo”, and the like are searched and “Gak”, “Gaek”, and “vomiting” corresponding to “vomit” are searched and thus the medical expressions such as “Gak hyeol”, “blood”, “vomiting”, or “hemoptysis” may be searched. Further, the disease names corresponding to the medical symptom expression may be searched.

Further, information on any one of an occurrence cause of diseases corresponding to the disease names, a treatment method, and a recommendation hospital may be displayed. Herein, the disease name may be plural and when any one of the plurality of disease names is selected, the information on any one of the occurrence cause of diseases corresponding to the selected disease names, the treatment method, and the recommendation hospital may be represented. Further, essential symptoms among the searched medical symptom expressions may be selected. In addition, when a signal selecting the essential symptoms is received, only the disease names including the essential symptoms may be represented. According to the exemplary embodiment of the present invention, a method for representing only the disease names including the essential symptoms arranges the disease names having high possibility of occurrence of essential symptoms in an ascending order or a descending order and thus may represent only the disease names.

FIG. 5 is a block diagram illustrating an apparatus 510 for representing symptoms graphically according to an exemplary embodiment of the present invention.

Referring to FIG. 5, the apparatus for representing symptoms graphically according to the exemplary embodiment of the present invention may include a display unit 511, an input unit 513, and a communication unit 515.

The display unit 511 may display a body model 201, an internal organ 401, and an organization map of the internal organic 401. According to the exemplary embodiment of the present invention, the display unit 511 may include a touch screen.

The input unit 513 may receive the first touch signal and the second touch signal which display the internal organ 401 and the organization map of the internal organ 401 by enlarging the body model 201. Further, the general symptom expression which may be generated from the organization corresponding to the organization map of the internal organ 401 may be received. The input unit 513 may include a means which may receive the information via the touch screen or a keyboard. According to the exemplary embodiment of the present invention, the input unit 513 may be implemented along with the display unit 511 and when the display unit displays the body model 201, the user may receive the general symptom expression by a touch function of the display.

The communication unit 515 transmits the general symptom expression to the medical specialty server and may receive the possible disease names based on the medical symptom expressions corresponding to the general symptom expressions and the information on the medical symptom expression and the organization from the medical specialty server 520. The communication unit 515 may be connected to the medical specialty server via a wired or wireless communication network. Herein, an example of the communication network may include a wireless LAN (WLAN), a Wi-Fi, a wireless broadband (Wibro), a world interoperability for microwave access (Wimax), a high speed downlink packet access (HSDPA), IEEE 802.16 long term evolution (LTE), a wireless mobile broadband service (WMBS), and the like. Further, an example of a local communication technology may include Bluetooth, radio frequency identification (RFID), infrared data association (IrDA), ultra wideband (UWB), ZigBee, and near field communication (NFC). Further, as an example of a wired communication technology may include USB communication, serial communication, an optical/coaxial cable, and the like.

The medical specialty server 520 may include a general symptom expression DB 521, a medical symptom expression DB 523, a disease name DB 525, a communication module 527, and a searching unit 529.

The general symptom expression DB 521 may store an expression on symptoms which are input by the user and the medical symptom expression DB 523 may store the medical symptom expression corresponding to the general symptom expression. The disease name DB 525 may include the information on any one of the occurrence cause of diseases, the treatment method, and the recommendation hospital.

The general symptom expression DB 521, the medical symptom expression DB 523, and the disease name DB 525 may include at least one form of a flash memory type storage medium, a hard disk type storage medium, a multimedia card micro type memory, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The communication module 527 may receive the general symptom expression from the communication unit 515. The communication module may be connected to the apparatus 510 for representing symptoms graphically in a wired/wireless manner, but the connection method is not particularly limited.

The searching unit 529 receives the general symptom expression from the apparatus for representing symptoms graphically and searches for the general symptom expression DB 521 corresponding to the general symptom expression, the medical symptom expression DB 523, and the disease name DB 525 to be able to obtain the medical symptom representation.

The methods according to various exemplary embodiments of the present invention may be implemented as a program instruction type that may be performed through various computer units and may be recorded in a computer readable medium. The computer readable medium may include program commands, data fields, a data structure, and the like, alone or a combination thereof.

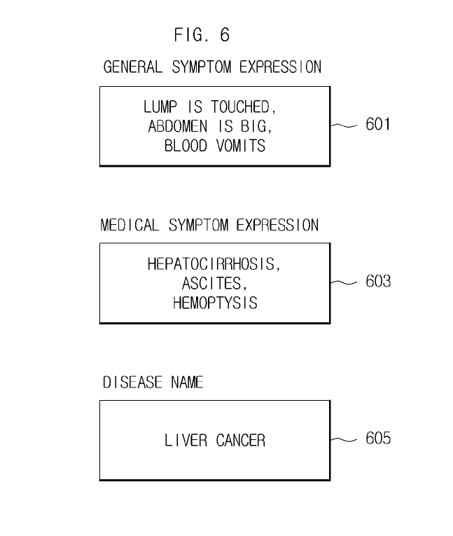

FIG. 6 is a diagram schematically illustrating a screen implemented by the apparatus for representing symptoms graphically according to the exemplary embodiment of the present invention. Referring to FIG. 6, the user may freely input the general symptom expression felt by the user to a general symptom expression input window 601. For example, when the user inputs the general symptom expressions such as “lump is touched”, “abdomen is big”, and “blood vomits”, hepatocirrhosis, ascites, hemoptysis, and the like may be displayed on a medical symptom expression output window 603. In this case, the disease name corresponding to the medical symptom expression may be displayed on a disease name output window 604. The disease name may be ascites and the general symptom expression input to the general symptom expression input window may be input by the selected method and the scope of the present invention is not limited to an input window and an output window illustrated in FIG. 6.

The program command recorded in the computer-readable recording medium may be designed and constituted especially for the present invention, or may be known and used to those skilled in a field of computer software. Examples of the computer-readable recording medium may include a magnetic medium such as a hard disk, a floppy disk, and a magnetic tape; an optical recording medium such as a CD-ROM, a DVD; a magneto-optical medium such as a floptical disk; and a hardware device specially constituted to store and perform program commands such as a ROM, a RAM, a flash memory, or the like. Examples of the program commands may include machine language codes such as being made by compilers as well as high-level language codes capable of being executed by computers using interpreters, or the like.

The above-mentioned hardware device may be constituted to be operated as at least one software module in order to perform an operation according to the present invention, and vice versa.

According to the exemplary embodiments of the present invention, the method and apparatus for representing symptoms graphically may allow the general public to easily and accurately input and store their own symptoms using the digital apparatus and transfer the stored symptoms to other systems or applications.

According to another exemplary embodiment of the present invention, the method and an apparatus for representing symptoms graphically may allow the medical expert or the computer to accurately process the symptom information on a user.

Hereinabove, the present invention has been described with reference to exemplary embodiments thereof. It will be understood by those skilled in the art to which the present invention pertains that the present invention may be implemented in a modified form without departing from essential characteristics of the present invention. Therefore, the exemplary embodiments disclosed herein should be considered in an illustrative aspect rather than a restrictive aspect. The scope of the present invention should be defined by the following claims rather than the above-mentioned description, and all technical spirits equivalent to the following claims should be interpreted as being included in the present invention.

What is claimed is:

1. A method for representing symptoms graphically, comprising:
displaying a body model on a display;
receiving a first touch signal for a location corresponding to a symptomatic site in the body model;
enlarging the location corresponding to the symptomatic site at which the first touch signal is received;
displaying internal organs corresponding to the enlarged location;
receiving a second touch signal at any one of the internal organs;
displaying an organization map of the internal organs corresponding to the location at which the second touch signal is received;
receiving a general symptom expression which is generated from an organization corresponding to the organization map;
acquiring a medical symptom expression by searching for the medical symptom expression corresponding to the general symptom expression from a medical specialty database; and
searching for possible disease names based on information on the medical symptom expression and the organization.

2. The method of claim 1, further comprising:
displaying information on any one of an occurrence cause of disease corresponding to the disease name, a treatment method, and a recommendation hospital.

3. The method of claim 1, further comprising:
prior to the receiving of the general symptom expression which is generated from the organization corresponding to the organization map, displaying the general symptom expression or the medical symptom expression which is generated from the organization corresponding to the organization map.

4. The method of claim 1, wherein the organization map of the internal organs includes an organization map for any one of the internal organs.

5. The method of claim 1, wherein the first touch signal and the second touch signal are signals which are generated by changing an electrical signal in the display using a capacitive type or a constant pressure type.

6. The method of claim 1, wherein the enlarging of the location corresponding to the symptomatic site at which the first touch signal is received is performed several times.

7. The method of claim 1, further comprising:
displaying the disease name on the display.

8. The method of claim 1, wherein the disease name is ascites.

9. The method of claim 7, further comprising:
displaying essential symptom in the disease name; and
displaying only the disease name including the essential symptom when the signal selecting the essential symptoms is received.

10. The method of claim 9, wherein the displaying of the only the disease name including the essential symptom includes arranging the disease names having high possibility of occurrence of essential symptoms in an ascending order or a descending order to represent only the disease name.

11. The method of claim 1, wherein the medical specialty database is a database including data obtained by matching the general symptom expression with the medical symptom expression.

12. An apparatus for representing symptoms graphically, comprising:
a display unit configured to display a body model, internal organs, an organization map of the internal organs;
an input unit configured to receive a first touch signal and a second touch signal to display the internal organs and the organization map of the internal organs by enlarging the body model and receive the general symptom expression which is generated from an organization corresponding to the organization map; and
a communication unit configured to transmit the general symptom expression to a medical specialty server and receive possible disease names based on a medical symptom expression corresponding to the general symptom expression and information on the medical symptom expression and the organization from the medical specialty server.

13. The apparatus of claim 12, wherein the medical specialty server includes:
a communication module configured to receive the general symptom expression from the communication unit;
a searching unit configured to search for the medical symptom expression corresponding to the general symptom expression;
a general symptom expression DB configured to store the general symptom expression;
a medical symptom expression DB configured to store the medical symptom expression corresponding to the general symptom expression; and
a disease name DB configured to store the disease name corresponding to the medical symptom expression.
